(19) United States
(12) Patent Application Publication
(10) Pub. No.: US 2026/0317242 A1
(43) Pub. Date: Oct. 15, 2026

(54) CERAMIC MATRIX COMPOSITE SINTERED BODY AND METHOD FOR PRODUCING THE SAME

(71) Applicant: MITSUBISHI ELECTRIC CORPORATION, Tokyo (JP)

(72) Inventor: Masami KUME, Tokyo (JP)

(73) Assignee: MITSUBISHI ELECTRIC CORPORATION, Tokyo (JP)

(21) Appl. No.: 19/484,379

(22) PCT Filed: Jun. 22, 2023
(86) PCT No.: PCT/JP2023/023153

§ 371 Date: Nov. 14, 2025

(51) Int. Cl. C04B 37/00; C04B 35/563; C04B 35/626; C04B 35/634; C04B 35/65; C04B 35/657; C04B 37/02; C04B 41/00

(52) U.S. Cl. CPC C04B 37/001; C04B 35/563; C04B 35/6267; C04B 35/63476; C04B 35/65; C04B 35/657; C04B 37/021; C04B 41/009; C04B 2235/3821; C04B 2235/3826; C04B 2235/425; C04B 2235/428; C04B 2235/48; C04B 2235/616; C04B 2237/36; C04B 2237/385; C04B 2237/40; C04B 2237/62; C04B 2237/84

(57) ABSTRACT

A ceramic matrix composite sintered body includes a matrix base material that includes a ceramic material containing boron carbide, silicon carbide, and metal silicon or a silicon alloy and containing no reinforcing fiber inside, and a fiber-reinforced composite material layer covering a surface of the matrix base material and containing a reinforcing fiber.

### FIELD

The present disclosure relates to a ceramic matrix composite sintered body that is formed by compositely combining a matrix base material made of a ceramic material with a fiber-reinforced composite material, and a method for producing the same.

### BACKGROUND

To take measures against a steep rise in fuel prices or meet the demand for reducing carbon dioxide (CO₂) emissions, increasing demands for energy saving are directed to air conditioners, cooling energy devices, and automobiles, aircrafts, and the like equipped with combustion engines. Air conditioners and cooling energy devices require high efficiency of compressors for energy saving. To achieve this, driving parts need to be light in weight or high in rigidity. To improve the efficiency of gas turbine engines and turbine generators, there is a need to elevate the operating temperature or reduce the weight of turbines.

Materials that satisfy these requirements have been studied, and iron-based, nickel-based, and cobalt-based alloys have been developed to improve high-temperature performance. However, weight reduction is still insufficient, and alternative lightweight materials have been investigated for weight reduction. Additionally, lightweight ceramic materials have attracted attention as heat-resistant materials because they have high heat resistance and have lower density than metal materials. However, ceramic materials are relatively brittle, and thus, Ceramic Matrix Composites (CMCs), which are formed by compositely combining ceramic materials with fibers or the like, have been in the spotlight as materials applicable to structural parts. In general, ceramic matrix composites are materials formed by compositely combining a ceramic matrix with reinforcing fibers. Patent Literature 1 discloses, as ceramic matrix composites, SiC/SiC formed by combining silicon carbide (SiC) used as a matrix and SiC fibers used as reinforcing fibers.

### CITATION LIST

### Patent Literature

Patent Literature 1: Japanese Patent No. 5825761

### SUMMARY OF INVENTION

### Problem to be Solved by the Invention

However, current SiC fiber products that have the highest performance have a tensile modulus, that is, Young's modulus of approximately 380 GPa and a specific gravity of approximately 2.85 or more to 3.1 or less. Additionally, the SiC fiber products have a specific modulus (=Young's modulus/specific gravity), which indicates an elastic modulus per specific gravity, of approximately 122.6 or more and 133.3 or less. For materials used for compressors, gas turbine engines, turbine generators, or the like described above, further improvement is required to enhance the specific modulus and reduce the brittleness of the ceramic material.

The present disclosure has been made in view of the above circumstances, and an object of the present disclosure is to provide a ceramic matrix composite sintered body capable of enhancing a specific modulus and reducing brittleness as compared with the conventional case.

### Means to Solve the Problem

In order to solve the above-described problems and achieve the object, a ceramic matrix composite sintered body according to the present disclosure comprises: a matrix base material that includes a ceramic material containing boron carbide, silicon carbide, and metal silicon or a silicon alloy and containing no reinforcing fiber inside; and a fiber-reinforced composite material layer covering a surface of the matrix base material and containing a reinforcing fiber.

### Effects of the Invention

The ceramic matrix composite sintered body according to the present disclosure has an effect of being able to enhance a specific modulus and reduce brittleness as compared with the conventional case.

### BRIEF DESCRIPTION OF DRAWINGS

FIG. 1 is a perspective view illustrating an example of a configuration of a ceramic matrix composite sintered body according to a first embodiment.

FIG. 2 is a transparent perspective view illustrating an example of a configuration of a ceramic matrix composite sintered body according to a second embodiment.

FIG. 3 is a perspective view illustrating an example of a configuration of a ceramic matrix composite sintered body according to a third embodiment.

FIG. 4 is an enlarged perspective view of a partial region R in FIG. 3.

FIG. 5 is a flowchart illustrating an example of a procedure of a method for producing a ceramic matrix composite sintered body according to a fourth embodiment.

FIG. 6 is a flowchart illustrating an example of a procedure of a method for producing a ceramic matrix composite sintered body according to a fifth embodiment.

FIG. 7 is a flowchart illustrating an example of a procedure of a method for producing a ceramic matrix composite sintered body according to a sixth embodiment.

FIG. 8 is a perspective view schematically illustrating the example of the procedure of the method for producing the ceramic matrix composite sintered body according to the sixth embodiment.

FIG. 9 is a perspective view schematically illustrating the example of the procedure of the method for producing the ceramic matrix composite sintered body according to the sixth embodiment.

FIG. 10 is a perspective view schematically illustrating the example of the procedure of the method for producing the ceramic matrix composite sintered body according to the sixth embodiment.

FIG. 11 is a perspective view schematically illustrating the example of the procedure of the method for producing the ceramic matrix composite sintered body according to the sixth embodiment.

### DESCRIPTION OF EMBODIMENTS

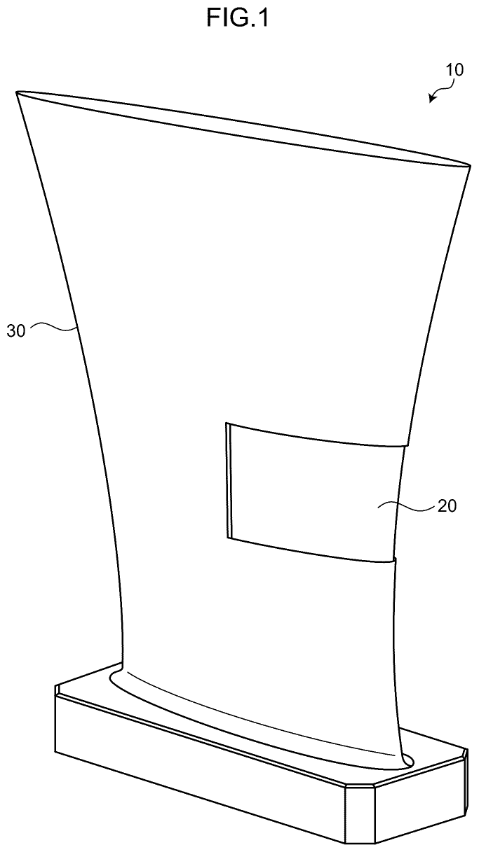

Hereinafter, a ceramic matrix composite sintered body according to embodiments of the present disclosure and a method for producing the same will be described in detail with reference to the drawings. Here, in the following drawings including FIG. 1, the identical reference signs denote the identical or corresponding components. The same applies to the entire description of the following embodiments. Additionally, the forms of components in the entire description are merely illustrative and not limited to the forms in the description.

### First Embodiment

FIG. 1 is a perspective view illustrating an example of a configuration of a ceramic matrix composite sintered body according to a first embodiment. FIG. 1 also illustrates an internal structure in which a surface layer of a ceramic matrix composite sintered body 10 is partially removed. A configuration of the ceramic matrix composite sintered body 10 will be described with reference to FIG. 1.

As illustrated in FIG. 1, the ceramic matrix composite sintered body 10 according to the first embodiment includes a matrix base material 20 that is made of a ceramic material and contains no reinforcing fiber inside, and a fiber-reinforced composite material layer 30 that covers a surface of the matrix base material 20, in this case, an outer surface of the matrix base material 20 and contains a reinforcing fiber. Note that the ceramic matrix composite sintered body 10 has a solid structure in which no cavity is provided in the inside of a structural body and the inside is filled with the matrix base material 20.

The matrix base material 20 contains, as a main component, boron carbide (B₄C), and contains, as other components, silicon carbide and metal silicon or a silicon alloy, which serves as silicon (Si). Examples of commercial products of the boron carbide include Boron Carbide Powder F240 available from 3M, and the like. The volume ratio of the boron carbide, which is a main component, in the composition of the matrix base material 20 is 50% or more. Boron carbide has a lower specific gravity than silicon carbide, metal silicon, and a silicon alloy. The presence of a large amount of the silicon or the silicon carbide in the matrix base material 20 results in a low apparent specific modulus. Thus, in order to enhance the specific modulus of the matrix base material 20, the volume ratio of the boron carbide, which solely has the highest specific modulus among the aforementioned compositional materials, in the matrix base material 20 is 50% or more, and the boron carbide is as a main component of the matrix base material 20.

The silicon is metal silicon or a silicon alloy. The reason why silicon is contained is that it is difficult to eliminate the silicon and fill with other components from the viewpoint of production process. Note that it is possible to substitute the silicon by voids. However, the voids correspond to defects of the material and degrade the properties of the material. Thus, filling the voids with the silicon is desirable rather than leaving the voids empty from the viewpoint of enhancing the properties of the material and enhancing the specific modulus.

The fiber-reinforced composite material layer 30 covers a surface portion of the matrix base material 20. The matrix base material 20 and the fiber-reinforced composite material layer 30 are integrated to constitute the ceramic matrix composite sintered body 10. The matrix base material 20 has a high specific modulus because the matrix base material 20 contains the boron carbide at a volume ratio of 50% or more, but is brittle because the matrix base material 20 is made of ceramics. Due to this brittleness, application to structural members and the like is difficult. To address this, the surface of the matrix base material 20 is integrally covered with the fiber-reinforced composite material layer 30, thereby significantly reducing crack propagation characteristics under an external impact. Furthermore, since the fiber-reinforced composite material layer 30 can achieve a structure that is lighter in weight and has a higher elastic modulus than the matrix base material 20, a composite combination of the matrix base material 20 with the fiber-reinforced composite material layer 30 can further enhance the specific modulus of the ceramic matrix composite sintered body 10 as compared with that of the matrix base material 20. As described above, the fiber-reinforced composite material layer 30 is made of materials having a lower specific gravity and a higher elastic modulus than the matrix base material 20.

The fiber-reinforced composite material layer 30 includes a matrix material and a reinforcing fiber. The fiber-reinforced composite material layer 30 is a material formed by compositely combining the matrix material with the reinforcing fiber.

Examples of the reinforcing fiber used in the fiber-reinforced composite material layer 30 include carbon fibers. Among the carbon fibers, a combination with pitch-based carbon fibers having an ultrahigh elastic modulus is particularly desirable. Some pitch-based carbon fibers have a specific gravity of 2.1 or more and 2.2 or less and an elastic modulus of 800 GPa or more, and in this case, the specific modulus is 360 or more. As described above, the pitch-based carbon fibers have a lower specific gravity and a higher elastic modulus than those of the boron carbide and the silicon carbide of the matrix base material 20. Thus, the surface of the matrix base material 20 is covered with the fiber-reinforced composite material layer 30 using pitch-based carbon fibers as the reinforcing fiber to form a composite, thus making it possible to enhance the specific modulus and reduce brittleness as compared with the conventional case.

Here, as the reinforcing fiber of the fiber-reinforced composite material layer 30, in addition to carbon fibers, ceramic fibers, polyacrylonitrile (PAN)-based carbon fibers, glass fibers, or aramid fibers may be used or any combination of two or more thereof may be used. Aramid fibers are an example of organic fibers.

The reinforcing fiber of the fiber-reinforced composite material layer 30 is selected in accordance with the characteristics required for the ceramic matrix composite sintered body 10. In one example, to further enhance the specific modulus of the ceramic matrix composite sintered body 10 integrally including the fiber-reinforced composite material layer 30, the use of pitch-based carbon fibers as the reinforcing fiber is preferable. On the other hand, to reduce the brittleness and to further improve a fracture toughness value of the ceramic matrix composite sintered body 10 integrally including the fiber-reinforced composite material layer 30, mainly combining with aramid fibers as the reinforcing fiber is preferable. Furthermore, a combination of the pitch-based carbon fibers with the aramid fibers makes it possible to improve both the specific modulus and the fracture toughness value of the ceramic matrix composite sintered body 10 integrally including the fiber-reinforced composite material layer 30.

The matrix material of the fiber-reinforced composite material layer 30 is, for example, resin. In a case of Fiber Reinforced Plastics (FRPs), examples of the resin include epoxy resins and the like, but resins other than the epoxy resins such as resins having higher heat resistance may be used in accordance with use environmental conditions. Additionally, as the resin, thermosetting resins such as a phenolic resin, a furan resin, a polyimide resin, a cyanate resin, and a vinyl ester resin can be used. Alternatively, thermoplastic resins such as nylon and a polyester resin, or resins that cure with a catalyst such as epoxy resins, can also be used. Combinations of these resins may also be employed.

Furthermore, the matrix material may be carbon, ceramics, or metal in addition to the resin. When the matrix material is resin such as plastic, the heat-resistant temperature of the use environment is restricted. For this reason, for use in environments requiring higher heat resistance, it is desirable to use the ceramic matrix composite sintered body 10 integrally including the fiber-reinforced composite material layer 30 using, as the matrix material, metal, carbon, or ceramics with superior heat resistance as compared with plastic materials, and the matrix base material 20.

When metal is used as the matrix material, the metal can be combined with light alloys such as aluminum alloys or magnesium alloys, which have a lower specific gravity than the matrix base material 20. When even higher heat resistance than metal is required, it is desirable to combine the metal with carbon or ceramics. When carbon is used as the matrix material, the carbon is susceptible to oxidation in air, and thus it is desirable to use the carbon in an environment of a non-oxidizing atmosphere. Alternatively, the ceramic matrix composite sintered body 10 may further include an anti-oxidation coating layer provided on the surface of the fiber-reinforced composite material layer 30. In other words, the ceramic matrix composite sintered body 10 may include in combination the carbon as the matrix material and the anti-oxidation coating layer provided on the surface of the fiber-reinforced composite material layer 30.

Here, a material in which the matrix material is ceramics and the reinforcing fiber is any selected from the group consisting of an inorganic fiber, a carbon fiber, and an organic fiber is a ceramic matrix composite. A material in which the matrix material is metal and the reinforcing fiber is any selected from the group consisting of an inorganic fiber, a carbon fiber, and an organic fiber is a Fiber Reinforced Metal (FRM). A material in which the matrix material is carbon and the reinforcing fiber is a carbon fiber is a Carbon Fiber Reinforced-Carbon Matrix-Composite (C/C composite). A material in which the matrix material is resin and the reinforcing fiber is any selected from the group consisting of an inorganic fiber, a carbon fiber, and an organic fiber is an FRP.

In other words, the fiber-reinforced composite material layer 30 includes at least one material selected from the group consisting of a ceramic matrix composite, an FRM, a C/C composite, and an FRP. Specifically, the matrix material of the fiber-reinforced composite material layer 30 includes at least one material selected from the group consisting of ceramics, metal, carbon, and resin, and the reinforcing fiber of the fiber-reinforced composite material layer 30 includes at least one material selected from the group consisting of an inorganic fiber, a carbon fiber, and an organic fiber.

As described above, the combination of the type of the reinforcing fiber and the type of the matrix material in the fiber-reinforced composite material layer 30 can be appropriately selected and combined in accordance with the use environmental conditions.

The ceramic matrix composite sintered body 10 according to the first embodiment includes the matrix base material 20 that includes a ceramic material containing boron carbide, silicon carbide, and metal silicon or a silicon alloy and containing no reinforcing fiber inside, and the fiber-reinforced composite material layer 30 covering a surface of the matrix base material 20 and containing the reinforcing fiber. The above-described material compositional combination of the matrix base material 20 of the ceramic matrix composite sintered body 10 can achieve a lower specific gravity and a higher elastic modulus, thus achieving a higher specific modulus. Additionally, the fiber-reinforced composite material layer 30, which has a higher elastic modulus and a lower density than the matrix base material 20, is compositely integrated with the matrix base material 20, thus achieving a further higher elastic modulus and a further lower specific gravity. Thus, the specific modulus of the ceramic matrix composite sintered body 10 can be made higher than that of the matrix base material 20. Furthermore, the integration of the matrix base material 20 with the fiber-reinforced composite material layer 30 can reduce the brittleness of the matrix base material 20 made of ceramics, that is, significantly enhance fracture toughness.

The volume ratio of the boron carbide in the matrix base material 20 is 50% or more. This can prevent a decrease in the inelastic modulus in the matrix base material 20 due to the inclusion of silicon carbide and silicon.

Furthermore, the fiber-reinforced composite material layer 30 includes at least one material selected from the group consisting of a ceramic matrix composite, an FRM, a C/C composite, and an FRP, and the reinforcing fiber includes at least one material selected from the group consisting of an inorganic fiber, a carbon fiber, and an organic fiber. By arranging the combination of the reinforcing fiber and the matrix material of the fiber-reinforced composite material layer 30 in accordance with the use environmental conditions of the ceramic matrix composite sintered body 10, the optimum composition for the specific modulus and the fracture toughness can be achieved.

### Second Embodiment

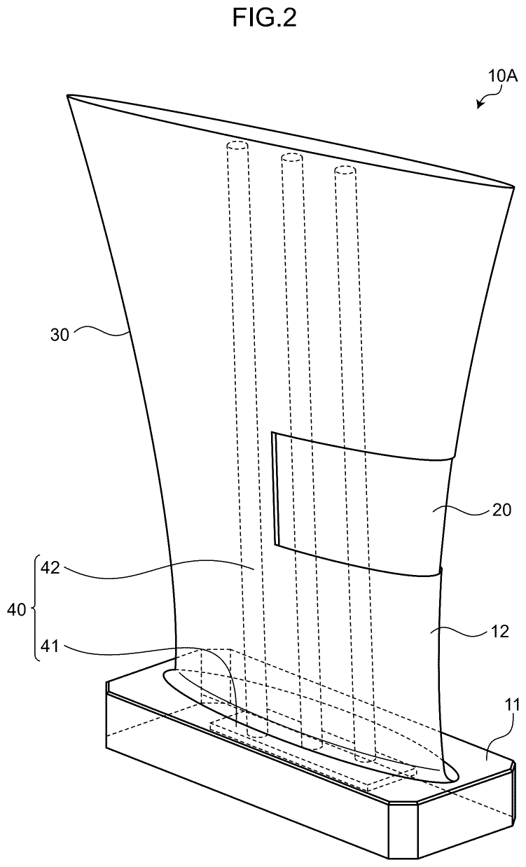

FIG. 2 is a transparent perspective view illustrating an example of a configuration of a ceramic matrix composite sintered body according to a second embodiment. FIG. 2 illustrates an internal structure in which a surface layer of a ceramic matrix composite sintered body 10A is partially removed, and an internal structure of the ceramic matrix composite sintered body 10A. A configuration of the ceramic matrix composite sintered body 10A will be described with reference to FIG. 2.

The ceramic matrix composite sintered body 10A according to the second embodiment further includes a reinforcing structure member 40 inside the matrix base material 20 in addition to the configuration of the first embodiment. The reinforcing structure member 40 is made of a fiber-reinforced composite material. Here, the “inside the matrix base material 20” means the inside of a structural object constituted by the ceramic matrix composite sintered body 10A. The reinforcing structure member 40 includes, for example, a plate 41, a rod 42, and the like. In this example, the ceramic matrix composite sintered body 10A has a solid structure in which the inside thereof is filled with materials instead of a hollow structure, the matrix base material 20 is disposed around the reinforcing structure member 40, and the reinforcing structure member 40 is integrated with the matrix base material 20.

The ceramic matrix composite sintered body 10A in FIG. 2 includes a base 11 and a main body 12 provided on the base 11 and having a fin shape. The base 11 includes the plate 41, which is an example of the reinforcing structure member 40. The main body 12 includes a plurality of rods 42, which is an example of the reinforcing structure member 40. The plurality of rods 42 is integrated with the plate 41. The ceramic matrix composite sintered body 10 according to the first embodiment has the structure in which only the surface of the matrix base material 20 is integrally covered with the fiber-reinforced composite material layer 30. The ceramic matrix composite sintered body 10A according to the second embodiment further includes the reinforcing structure member 40 made of the fiber-reinforced composite material inside the matrix base material 20, and the reinforcing structure member 40 is integrated with the matrix base material 20.

The ceramic matrix composite sintered body 10A includes the reinforcing structure member 40 made of the fiber-reinforced composite material inside the matrix base material 20, thereby achieving weight reduction, enhancement of specific modulus, and reduction of brittleness of the matrix base material 20. The inclusion of the reinforcing structure member 40, such as the plate 41, the rods 42, and the like, made of the fiber-reinforced composite material inside the matrix base material 20 can prevent cracks or the like that occur in the matrix base material 20 from propagating throughout and causing separation. The fiber-reinforced composite material constituting the reinforcing structure member 40 has a lower specific gravity and a higher elastic modulus than the matrix base material 20, thus resulting in a low apparent specific gravity of the matrix base material 20 having the reinforcing structure member 40 and an enhanced elastic modulus.

Note that the reinforcing fiber and the matrix material used in the fiber-reinforced composite material layer 30 and the reinforcing structure member 40 are not limited to a unique combination similarly to the first embodiment, and can be composed in any combination in accordance with the use environmental conditions.

The ceramic matrix composite sintered body 10A according to the second embodiment further includes the reinforcing structure member 40 made of the fiber-reinforced composite material inside the matrix base material 20, and the reinforcing structure member 40 is integrated with the matrix base material 20. This can further enhance the strength and rigidity of the matrix base material 20 as compared with the case of the first embodiment. Additionally, since the reinforcing structure member 40 made of the fiber-reinforced composite material has a lower density than the matrix base material 20, it is possible to further lower the density of the entire ceramic matrix composite sintered body 10A as compared with the case of the first embodiment.

### Third Embodiment

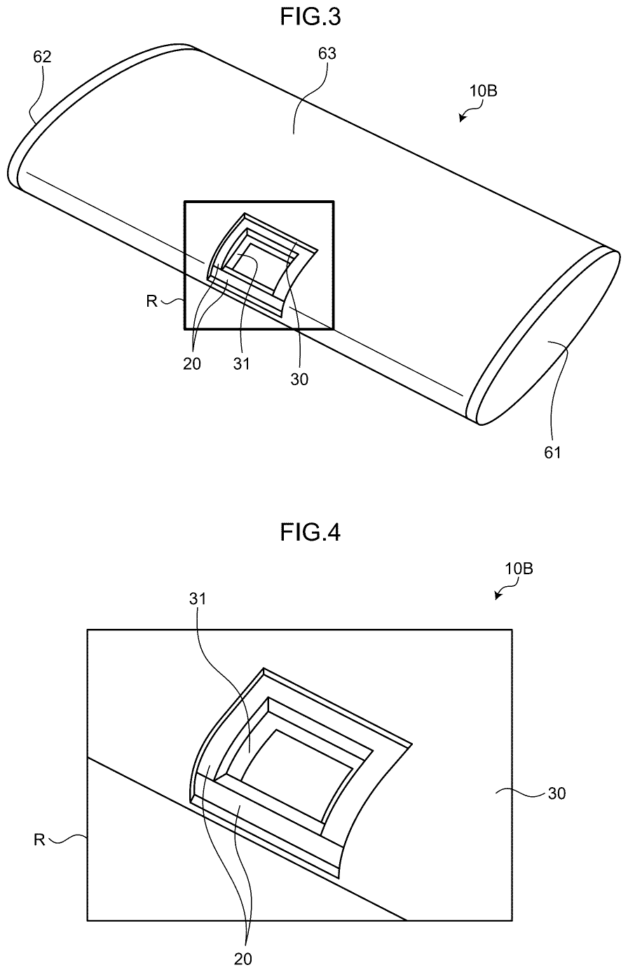

FIG. 3 is a perspective view illustrating an example of a configuration of a ceramic matrix composite sintered body according to a third embodiment. FIG. 4 is an enlarged perspective view of a partial region R in FIG. 3. FIGS. 3 and 4 also illustrate an internal structure in which the surface layer of a ceramic matrix composite sintered body 10B is partially removed. A configuration of the ceramic matrix composite sintered body 10B will be described with reference to FIGS. 3 and 4.

The ceramic matrix composite sintered body 10 according to the first embodiment, and the ceramic matrix composite sintered body 10A according to the second embodiment each have the solid structure, but the ceramic matrix composite sintered body 10B according to the third embodiment is intended for a hollow structure. In the examples of FIGS. 3 and 4, the ceramic matrix composite sintered body 10B has a structure having a hollow interior and an elliptic cylindrical shape. The ceramic matrix composite sintered body 10B according to the third embodiment includes the matrix base material 20, the fiber-reinforced composite material layer 30 formed on the outer surface of the matrix base material 20, and a fiber-reinforced composite material layer 31 formed on the inner surface of the matrix base material 20. In other words, not only the fiber-reinforced composite material layer 30 is provided on the outer surface of the matrix base material 20 that is hollow and has an elliptic cylindrical shape, but also the fiber-reinforced composite material layer 31 is provided on the inner surface of the matrix base material 20 that has the elliptic cylindrical shape. Furthermore, the matrix base material 20 and the fiber-reinforced composite material layer 30 on the outer surface thereof are integrated with the matrix base material 20 and the fiber-reinforced composite material layer 31 on the inner surface thereof. Note that the “inner surface” refers to the surface of the matrix base material 20 or the ceramic matrix composite sintered body 10B facing the space of the hollow structure of the ceramic matrix composite sintered body 10B.

Making the inside of the matrix base material 20 hollow and the matrix base material 20 thinner can achieve a lightweight structure. However, since the matrix base material 20 includes a ceramic material and the ceramic material is brittle, the matrix base material 20 is likely to crack when receiving a local impact. Thus, the outer surface and the inner surface of the matrix base material 20 are compositely combined respectively with the fiber-reinforced composite material layers 30 and 31 having high fracture toughness and being less likely to crack, thus making it possible to mitigate and diffuse a local impact applied to the ceramic material. As a result, it is possible to further enhance strength and fracture toughness as a structural body.

The fiber-reinforced composite material used for the fiber-reinforced composite material layer 31 on the inner surface in the third embodiment can be composed in various combinations similarly to the fiber-reinforced composite material layers 30 described in the first and second embodiments. Additionally, when the fiber-reinforced composite material layers 30 and 31 respectively on the outer surface and the inner surface of the matrix base material 20 are composed in the same material combination, it is desirable to make the elastic modulus of the fiber-reinforced composite material layer 31 on the inner surface lower and flexibility thereof higher than that of the fiber-reinforced composite material layer 30 on the outer surface. Thus, the elastic modulus can be changed by adjusting the content ratio between the matrix material and the reinforcing fiber in the fiber-reinforced composite material layers 30 and 31. In one example, the elastic moduli of the fiber-reinforced composite material layer 31 on the inner surface and the fiber-reinforced composite material layer 30 on the outer surface can be controlled by setting the volume content of the reinforcing fiber to 55% in the case of the fiber-reinforced composite material layer 30 on the outer surface, and setting the volume content of the reinforcing fiber to 45% in the case of the fiber-reinforced composite material layer 31 on the inner surface. Alternatively, instead of controlling the elastic modulus by changing the volume content, the elastic modulus may be changed by combining different fibers. In one example, a highly elastic pitch-based carbon fiber can be used as the reinforcing fiber of the fiber-reinforced composite material layer 30 on the outer surface, and a PAN-based carbon fiber can be used as the reinforcing fiber of the fiber-reinforced composite material layer 31 on the inner surface. However, the reinforcing fiber is not limited to a carbon fiber, and may include at least one material selected from the group consisting of a ceramic fiber, an inorganic fiber, a glass fiber, and an organic fiber. The organic fiber includes an aramid fiber or the like. Furthermore, the matrix material may include, in addition to the resin, at least one material selected from the group consisting of carbon, metal, and ceramics.

As described above, by making the elastic modulus of the fiber-reinforced composite material layer 31 on the inner surface lower than that of the fiber-reinforced composite material layer 30 on the outer surface, the brittleness, that is, the ease of cracking of the ceramic material of the matrix base material 20 can be reduced. In other words, covering the surface of the matrix base material 20 with the fiber-reinforced composite material layer 30 improves toughness, making the ceramic matrix composite sintered body 10B less likely to crack. However, the fiber-reinforced composite material layer 30, which has low characteristics, specifically a low elastic modulus may lower the characteristics, specifically the elastic modulus, of the matrix base material 20. For this reason, ideally, the matrix base material 20 is covered with a fiber-reinforced composite material having a higher elastic modulus and superior toughness than the matrix base material 20, that is, being less likely to crack. In the case of the fiber-reinforced composite material, the toughness tends to decrease as the elastic modulus increases, but the toughness is still sufficiently higher than that of the ceramic material. For this reason, for the outer surface having a high degree of structural influence on rigidity, priority is given to rigidity, and the fiber-reinforced composite material layer 30 having a high elastic modulus is used, and for the inner surface having a small degree of structural influence on rigidity, the fiber-reinforced composite material layer 31 having higher toughness and a low elastic modulus is used. This enables efficient enhancement of the elastic modulus and efficient improvement of fracture toughness.

Note that, when the highest priority is not given to enhancement of rigidity, the fiber-reinforced composite material layer 30 having a low elastic modulus, that is, high fracture toughness may be set on the surface. In other words, there are the following three possible combinations of the fiber-reinforced composite material layer 30 on the outer surface and the fiber-reinforced composite material layer 31 on the inner surface.
(1) When priority is given to enhancement of rigidity of the ceramic matrix composite sintered body 10B and improvement in toughness is not so much required: the fiber-reinforced composite material layer 30 on the outer surface and the fiber-reinforced composite material layer 31 on the inner surface are each made of a highly elastic fiber-reinforced composite material layer. In one example, when the fiber-reinforced composite material layers 30 and 31 are each a fiber-reinforced composite material in which the elastic modulus can be controlled by changing the volume content of the reinforcing fiber, the content of the reinforcing fiber in the fiber-reinforced composite material may simply be made relatively larger, in one example, larger than that in a case (2) below.
(2) When priority is given to enhancement of toughness of the ceramic matrix composite sintered body 10B and improvement in rigidity is not so much required: the fiber-reinforced composite material layer 30 on the outer surface and the fiber-reinforced composite material layer 31 on the inner surface are each made of a low elastic fiber-reinforced composite material layer. In one example, when the fiber-reinforced composite material layers 30 and 31 are each a fiber-reinforced composite material in which the elastic modulus can be controlled by changing the volume content of the reinforcing fiber, the content of the reinforcing fiber in the fiber-reinforced composite material may simply be made relatively lower, in one example, lower than that in a case (1) above.
(3) When a balance between rigidity and toughness is required: the fiber-reinforced composite material layer 30 on the outer surface is made of a highly elastic fiber-reinforced composite material layer, and the fiber-reinforced composite material layer 31 on the inner surface is made of a low elastic fiber-reinforced composite material layer. In one example, when the fiber-reinforced composite material layers 30 and 31 are each a fiber-reinforced composite material in which the elastic modulus can be controlled by changing the volume content of the reinforcing fiber, as described above, the content of reinforcing fiber in the fiber-reinforced composite material layer 31 on the inner surface may simply be made relatively lower than that in the fiber-reinforced composite material layer 30 on the outer surface.

Note that, in the example of FIG. 3, the ceramic matrix composite sintered body 10B, which is hollow and has two bottom surfaces 61 and 62 and an elliptic cylindrical side surface 63 connecting the two bottom surfaces 61 and 62, is exemplified, but the ceramic matrix composite sintered body 10B may have a structure in which at least one of the two bottom surfaces 61 and 62 is not provided. Instead of the elliptic cylindrical shape, a cylindrical shape or a polygonal cylindrical shape may be employed.

The ceramic matrix composite sintered body 10B according to the third embodiment includes the fiber-reinforced composite material layers 30 and 31 respectively on the outer surface and the inner surface of the matrix base material 20 having a hollow structure inside thereof. By making the matrix base material 20 hollow, further weight reduction can be achieved as compared with the matrix base material 20 having a solid structure having the same outer shape. Additionally, by covering the inner surface of the matrix base material 20 with the fiber-reinforced composite material layer 31 in addition to the outer surface of the matrix base material 20, the crack resistance is further enhanced, and the ceramic matrix composite sintered body 10B having a lightweight and highly rigid structure can be achieved.

Additionally, the elastic moduli of the fiber-reinforced composite material layer 31 on the inner surface and the fiber-reinforced composite material layer 30 on the outer surface in the ceramic matrix composite sintered body 10B having the hollow structure are changed. This can obtain a green body having characteristics suitable for the use environmental conditions.

### Fourth Embodiment

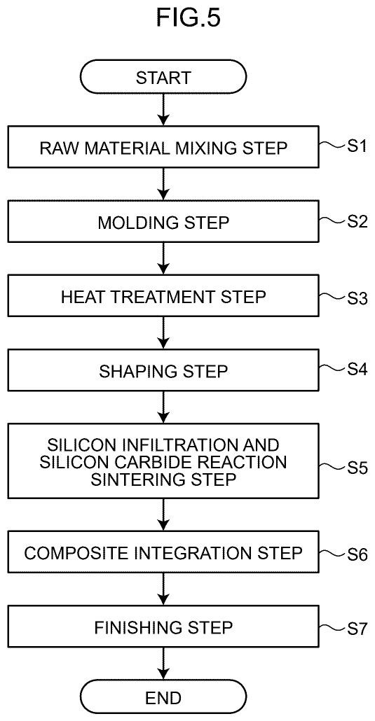

In a fourth embodiment, a method for producing the ceramic matrix composite sintered body 10 described in the first embodiment will be described. FIG. 5 is a flowchart illustrating an example of a procedure of a method for producing the ceramic matrix composite sintered body according to the fourth embodiment. As illustrated in FIG. 5, the method for producing the ceramic matrix composite sintered body 10 includes a raw material mixing step (step S1), a molding step (step S2), a heat treatment step (step S3), a shaping step (step S4), a silicon infiltration and silicon carbide reaction sintering step (step S5), a composite integration step (step S6), and a finishing step (step S7). Each step will be described below.

The raw material mixing step of step S1 is a step of obtaining a raw material mixture containing a boron carbide powder, a binder resin as a carbon precursor, and a matrix filler as a silicon carbide precursor. The matrix filler is, for example, carbon or a graphite powder. In the raw material mixing step, the boron carbide powder, the binder resin, and the matrix filler are uniformly mixed at a predetermined mixing ratio to form a raw material mixture. An average particle size distribution of the powder raw materials in the raw material mixture desirably has two or more different levels.

Table 1 is a table showing an example of the relationship of average particle size distributions of boron carbide as fine particle raw materials to be used and carbon as a matrix filler of a silicon carbide precursor. In one example, in Case 1 in which the average particle size distribution of the boron carbide as the raw material fine particles to be used has one level, two or more levels of average particle size distributions of carbon raw materials of the matrix filler to be mixed are used. In this case, when two levels of average particle size distributions of the carbon raw materials of the matrix filler are PD1 (C) and PD2 (C), and a relationship of PD1 (C)>PD2 (C) is established, as illustrated in Table 1, an average particle size distribution PD (B₄C) of the boron carbide is desirably between the two levels of average particle size distributions PD1 (C) and PD2 (C) of the carbon raw materials of the matrix filler. The carbon raw material of the matrix filler having a larger average particle size distribution has an effect of widening the dispersion interval of the boron carbide particles and reducing density. The carbon raw material of the matrix filler having a smaller average particle size distribution than the boron carbide fills a part of gaps between boron carbide particles. With a structure in which these raw materials are fixed with the binder resin, the green body is formed in the molding step of next step S2.

### [Table 1]

TABLE 1

| | | | Relationship of |
|---|---|---|---|
| | Boron | Matrix filler | average particle |
| | carbide: B₄C | (filler carbon: C) | size distributions |
| Case 1 | ◯: One level | ◯: Two or more | PD1(C) > PD(B₄C) > |
| | | levels | PD2(C) |
| Case 2 | ◯: Two or more | ◯: Two or more | PD1(C) > PD1(B₄C) > |
| | levels | levels | PD2(B₄C) > PD2(C) |

Note that, as shown in Case 2 of Table 1, the average particle size distribution of the boron carbide is not limited to having one level, and may have two or more levels. When two levels of average particle size distributions of the boron carbide are PD1 (B₄C) and PD2 (B₄C), and a relationship of PD1 (B₄C)>PD2 (B₄C) is established, the two levels of average particle size distributions PD1 (B₄C) and PD2 (B₄C) of the boron carbide are desirably between the two levels of average particle size distributions PD1 (C) and PD2 (C) of the carbon raw materials.

Here, the graphite powder is given as an example of the carbon raw materials of the matrix filler, but milled fibers of carbon fibers may be used in combination in addition to the graphite powder.

The molding step of step S2 is a step of charging, into a mold, the raw material mixture mixed in the raw material mixing step of step S1, and heating and pressurizing the raw material mixture to cure the binder resin, thereby obtaining a green body.

The heat treatment step of step S3 is a step of subjecting the green body molded in the molding step of step S2 to a heat treatment in an inert atmosphere, and carbonizing the binder resin in the green body through thermal decomposition to obtain a fired body. Since the green body contains only a small amount of binder resin components, the generation of decomposition gases and thermal shrinkage during the heat treatment are small. For this reason, special operations such as pressurizing during the heat treatment and fixing the shape with a jig are unnecessary, but the heat treatment may be performed while a load is applied using a jig or the like on purpose, to induce forced deformation.

The shaping step of step S4 is a step of shaping the fired body obtained in the heat treatment step of step S3 into a desired shape through machining. The fired body is a matrix material obtained by carbonizing the binder resin, and is a porous material including voids in which the boron carbide powder and the carbon of the matrix filler are fixed. Thus, there is a feature that the fired body can be easily shaped with a normal machining tool. The shaped fired body is hereinafter referred to as a substrate.

The silicon infiltration and silicon carbide reaction sintering step of step S5 is a step of heating the substrate obtained in the shaping step of step S4 together with metal silicon or a silicon alloy to infiltrate the metal silicon or the silicon alloy into the substrate, reacting the infiltrated metal silicon or silicon alloy with carbon to form silicon carbide, and sintering the substrate, that is, the boron carbide powder to obtain a sintered body. Specifically, the substrate is heated together with the metal silicon or the silicon alloy in a vacuum or in an inert atmosphere. Thus, the melted metal silicon or the melted silicon alloy is infiltrated into the substrate, reacted with the carbon inside the substrate to form silicon carbide, and the boron carbide powder is sintered to obtain a sintered body. This sintered body serves as the matrix base material 20. Metal silicon or a silicon alloy required for the silicon-carbide reaction can be continuously supplied from the outside, and the carbon contained inside the substrate reacts with the metal silicon or the silicon alloy to form silicon carbide, which causes volume expansion. Thus, the voids of the substrate are filled with the silicon carbide generated by the reaction and the infiltrated metal silicon or silicon alloy. As a result, the sintered body becomes a dense sintered body substantially free of voids. Furthermore, shrinkage during sintering that occurs at the time of sintering of the conventional ceramic material hardly occurs before and after sintering. In other words, cracking and deformation during sintering hardly occur. This makes it possible to easily manufacture structures with uneven wall thickness, hollow structures, or large-scale structures.

The composite integration step of step S6 involves compositely combining the surface of the sintered body obtained in the silicon infiltration and silicon carbide reaction sintering step of step S5 with the fiber-reinforced composite material layer 30, and integrating the sintered body with the fiber-reinforced composite material layer 30. In other words, the composite integration step is a step of laminating the fiber-reinforced composite material layer 30 on the outer surface of the sintered body, and integrating the fiber-reinforced composite material layer 30 with the sintered body. The integral disposition of the fiber-reinforced composite material layer 30 on the surface of the sintered body significantly reduces the crack propagation characteristics and the ease of cracking of the sintered body made of the ceramic material, that is, the matrix base material 20, under external impact. In other words, the crack propagation characteristics can be restrained, and the crack resistance can be enhanced in the ceramic matrix composite sintered body 10 including the matrix base material 20 and the fiber-reinforced composite material layer 30 integrally formed on the surface of the matrix base material 20.

In the composite integration step, a prepreg, which is a reinforcing fiber impregnated with resin in advance, is disposed on the surface of the sintered body, and a composite integration treatment of the prepreg is performed to form the fiber-reinforced composite material layer 30 on the surface of the sintered body. In a case where the resin is a thermosetting resin, the resin is cured by heating the prepreg as the composite integration treatment, thus forming the fiber-reinforced composite material layer 30 integrally on the surface of the sintered body. In a case where the resin is a reactive resin, the resin is cured at a low temperature by treating the resin using a catalyst or the like as the composite integration treatment. This forms the fiber-reinforced composite material layer 30 integrally on the surface of the sintered body. In a case where the resin is a thermoplastic resin, the resin is melted as the composite integration treatment, and the melted resin is brought into close contact with the surface of the sintered body, thus forming the fiber-reinforced composite material layer 30 integrally on the surface of the sintered body.

In the composite integration step using the fiber-reinforced composite material, materials to be used and treatment conditions are changed in accordance with characteristics required for the matrix material of the fiber-reinforced composite material layer 30 based on the use environmental conditions of the ceramic matrix composite sintered body 10.

In one example, when heat resistance is unnecessary, the fiber-reinforced composite material layer 30 can be made of the FRP by using resin as the matrix material of the fiber-reinforced composite material layer 30.

In another example, when higher heat resistance is required, carbon is used instead of the resin as the matrix material of the fiber-reinforced composite material layer 30. When the matrix material is made of carbon, a phenolic resin can be used as a matrix raw material of the fiber-reinforced composite material layer 30 used in the composite integration step. Thereafter, the heat treatment is performed in an inert atmosphere to carbonize the phenolic resin, thus converting the phenolic resin into carbon. In order to additionally fill the matrix material with carbon as appropriate, the resin impregnation and the heat treatment may be repeated to fill the matrix material with carbon. Alternatively, the matrix material may be filled with the carbon by a thermal decomposition method such as a Chemical Vapor Deposition (CVD) method or a Chemical Vapor Infiltration (CVI) method. The conversion of the matrix material of the fiber-reinforced composite material layer 30 into carbon can enhance heat resistance in an inert atmosphere as compared with the case of using the resin as the matrix material.

In another example, when heat resistance in an oxidizing atmosphere is required, the matrix material may be made of metal and the fiber-reinforced composite material layer 30 may be made of the FRM, or alternatively, the matrix material may be made of ceramics and the fiber-reinforced composite material layer 30 may be made of a ceramic matrix composite.

In a case where the fiber-reinforced composite material layer 30 is made of the FRM, in one example, a preform material is molded and integrated in such a way that a preformed yarn or a sheet, which is formed by covering the reinforcing fiber with an aluminum alloy, is shaped on a surface to obtain a preform material, and the preform material is heated to the vicinity of the melting point of the aluminum alloy while being pressed by pressurization. Here, the metal used in the preform material can use any combination of a fiber and a metal that can be used as the FRM, such as a magnesium alloy in addition to the aluminum alloy.

In a case where the fiber-reinforced composite material layer 30 is made of a ceramic matrix composite, taking a case where the matrix material is made of silicon carbide as an example, the matrix material of the fiber-reinforced composite material layer 30 is converted into carbon through the heat treatment, and then the metal silicon or the silicon alloy is used to react with the carbon in a vacuum or an inert atmosphere to form silicon carbide, thus converting the matrix material into the silicon carbide.

In the case of severe use environmental conditions or in the case where it is required to enhance long-term reliability, a coating layer for reaction inhibition such as oxidation prevention can be further formed on the surface of the fiber-reinforced composite material layer 30. A material of the coating layer and a coating method can be selected in accordance with the use environmental conditions. Examples of the coating method include a CVD method, a plasma spraying method, and an ion sputtering method.

Thus, the fiber-reinforced composite material layer 30 used in the composite integration step includes at least one material selected from the group consisting of a ceramic matrix composite, an FRM, a C/C composite, and an FRP. Additionally, the reinforcing fiber of the fiber-reinforced composite material layer 30 includes at least one material selected from the group consisting of an inorganic fiber, a carbon fiber, and an organic fiber.

The finishing step of step S7 is a step of finishing the sintered body, which is formed by integrating the sintered body with the fiber-reinforced composite material layer 30 in the composite integration step of step S6, into an article shape. By performing processing of finishing the sintered body into a final shape, an article made of the ceramic matrix composite sintered body 10 can be obtained. Since the sintered body before final finishing has a shape close to the shape of the final article, the sintered body can be finished with a small amount of processing, thus significantly improving productivity.

According to the fourth embodiment, the ceramic matrix composite sintered body 10 is produced by compositely integrating the surface of the matrix base material 20 with the fiber-reinforced composite material layer 30. This allows the ceramic matrix composite sintered body 10 to have an even higher elastic modulus and an even lower specific gravity than the matrix base material 20. In other words, it is possible to produce the ceramic matrix composite sintered body 10 having an even higher specific modulus than the matrix base material 20. Furthermore, the integration of the matrix base material 20 made of a ceramic material with the fiber-reinforced composite material layer 30 can reduce the brittleness of the matrix base material 20, that is, significantly enhance fracture toughness.

### Fifth Embodiment

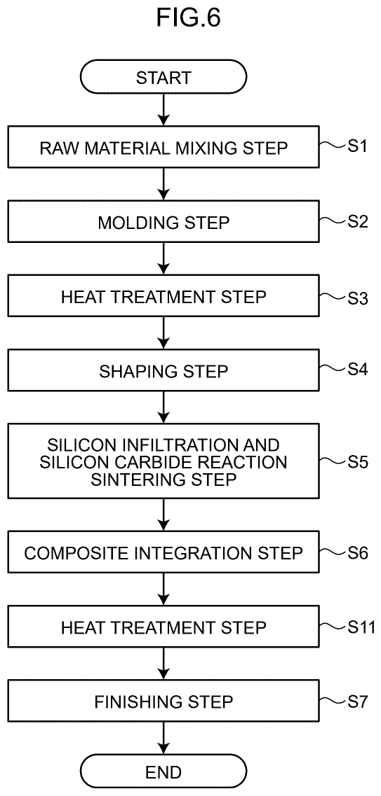

In a fifth embodiment, a method for producing the ceramic matrix composite sintered body 10A described in the second embodiment will be described. FIG. 6 is a flowchart illustrating an example of a procedure of a method for producing a ceramic matrix composite sintered body according to the fifth embodiment. Note that the identical steps as those in FIG. 5 describing the fourth embodiment are denoted by the identical step numbers, and the description thereof will be omitted.

The method for producing the ceramic matrix composite sintered body 10A described in the second embodiment is basically the same as the method for producing the ceramic matrix composite sintered body 10 described in the fourth embodiment. However, in the shaping step of step S4, in addition to shaping of the outer shape, processing for embedding the reinforcing structure member 40 inside the matrix base material 20 is newly added. The reinforcing structure member 40 inside the matrix base material 20 includes, for example, the plate 41 and the rod 42, which are each made of the fiber-reinforced composite material. Processing necessary for embedding the reinforcing structure member 40 including the plate 41 and the rod 42 is performed on the fired body.

At this time, in the silicon infiltration and silicon carbide reaction sintering step of step S5, silicon carbide reaction sintering may be performed in which the inside of the embedded reinforcing structure member 40 is also caused to undergo a reaction together, thus converting the matrix material of the reinforcing structure member 40 into silicon carbide in the same manner as the fired body. Alternatively, in the silicon infiltration and silicon carbide reaction sintering step of step S5, the embedded reinforcing structure member 40 is integrated with the fired body, but may not necessarily be converted into silicon carbide. In other words, the matrix material of the reinforcing structure member 40 may be made of the FRP, which is plastic resin.

Furthermore, since the fiber-reinforced composite material layer 30 integrated in the composite integration step of step S6 is not subjected to the heat treatment as in the silicon infiltration and silicon carbide reaction sintering step of step S5, the matrix material remains as the resin. In one example, in a case where the resin is a thermosetting resin, the fiber-reinforced composite material layer 30 is heated only to approximately one hundred and several tens of degrees Centigrade, which is a temperature necessary for curing the resin. Thus, the fiber-reinforced composite material layer 30 may be made of a C/C composite in which the matrix material is carbon instead of the resin.

In this case, as illustrated in FIG. 6, the method for producing the ceramic matrix composite sintered body 10A further includes a heat treatment step (step S11) after the composite integration step of step S6. In the heat treatment step of step S11, the resin component of the fiber-reinforced composite material layer 30 is carbonized. As a result, the fiber-reinforced composite material layer 30 is converted into a C/C composite. As described above, the heat treatment step of step S11 is a step performed for controlling the material of the matrix material of the fiber-reinforced composite material layer 30 as appropriate. Thereafter, the finishing step of step S7 is performed.

Note that the heat treatment step of step S11 may be performed after the composite integration step of step S6 in the fourth embodiment. Furthermore, as appropriate, a coating layer may be formed on the surface of the obtained ceramic matrix composite sintered body 10A.

In the fifth embodiment, the reinforcing structure member 40 made of the fiber-reinforced composite material is embedded in the inside of the fired body in the shaping step, and the reinforcing structure member 40 is integrated with the fired body in the silicon infiltration and silicon carbide reaction sintering step. This can produce the ceramic matrix composite sintered body 10A including the reinforcing structure member 40 inside the matrix base material 20 as described in the second embodiment.

### Sixth Embodiment

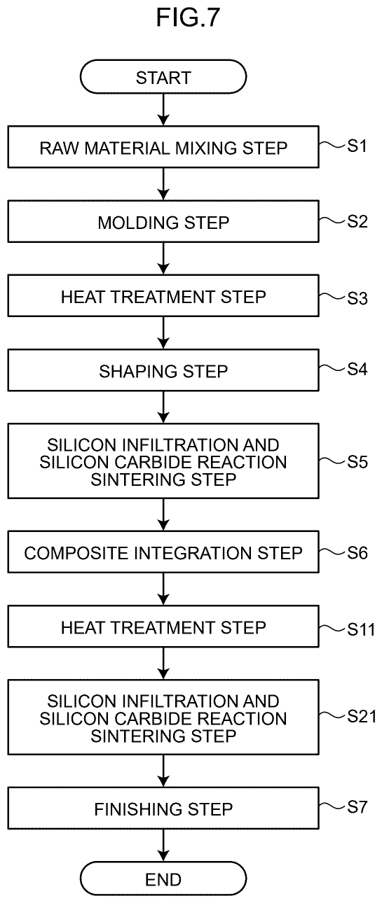

In a sixth embodiment, a method for producing the ceramic matrix composite sintered body 10B described in the third embodiment will be described. FIG. 7 is a flowchart illustrating an example of a procedure of a method for producing a ceramic matrix composite sintered body according to the sixth embodiment. Note that the identical steps as those in FIG. 5 describing the fourth embodiment and in FIG. 6 describing the fifth embodiment are denoted by the identical step numbers, and the description thereof will be omitted.

The method for producing the ceramic matrix composite sintered body 10B described in the third embodiment is basically the same as the method for producing the ceramic matrix composite sintered body 10 described in the fourth embodiment. However, in the shaping step of step S4, in addition to shaping of the outer shape, processing of forming the substrate to internally have a hollow structure is added.

When the hollow structure is complicated, the ceramic matrix composite sintered body 10B can also be produced by dividing the substrate into a plurality of portions and then combining and joining the plurality of divided portions.

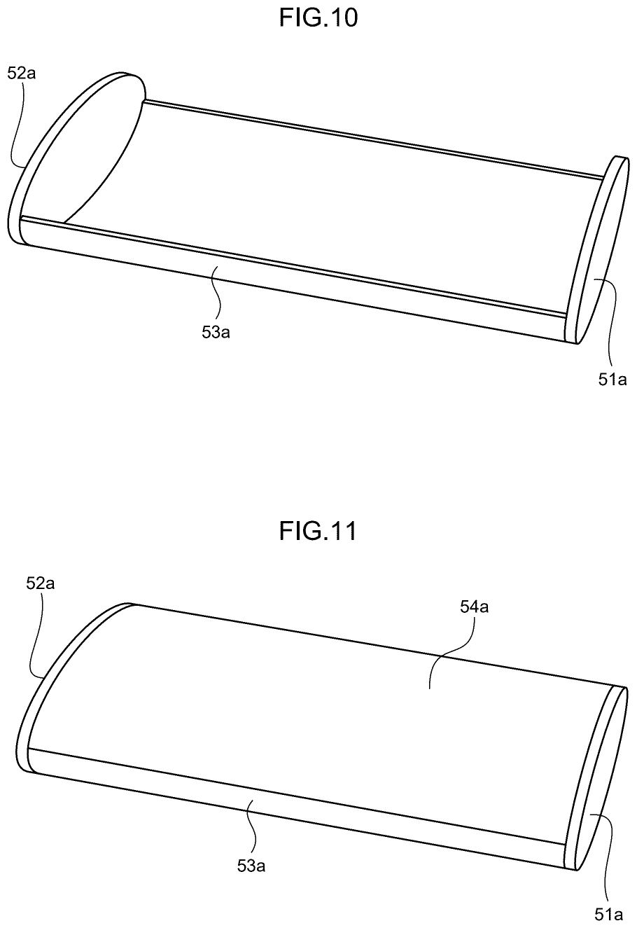

FIGS. 8 to 11 are perspective views each schematically illustrating an example of the procedure of the method for producing the ceramic matrix composite sintered body according to the sixth embodiment. As illustrated in FIG. 8, a substrate 50 corresponding to the shape of the finished product is appropriately divided into a plurality of portions. In other words, the substrate 50 is divided into simple shell structures. In the example of FIG. 8, the substrate 50 having an elliptic cylindrical shape is divided into individual portions, that is, two bottom surfaces 51 and 52 and two side surfaces 53 and 54. In this case, after the silicon infiltration and silicon carbide reaction sintering step of step S5 is performed on each of the divided portions, the fiber-reinforced composite material layers 30 and 31 are respectively disposed on the outer surface and the inner surface in the composite integration step, the divided portions are assembled, and then the composite integration treatment of the fiber-reinforced composite material layers 30 and 31 is performed, thus enabling the portions to be joined.

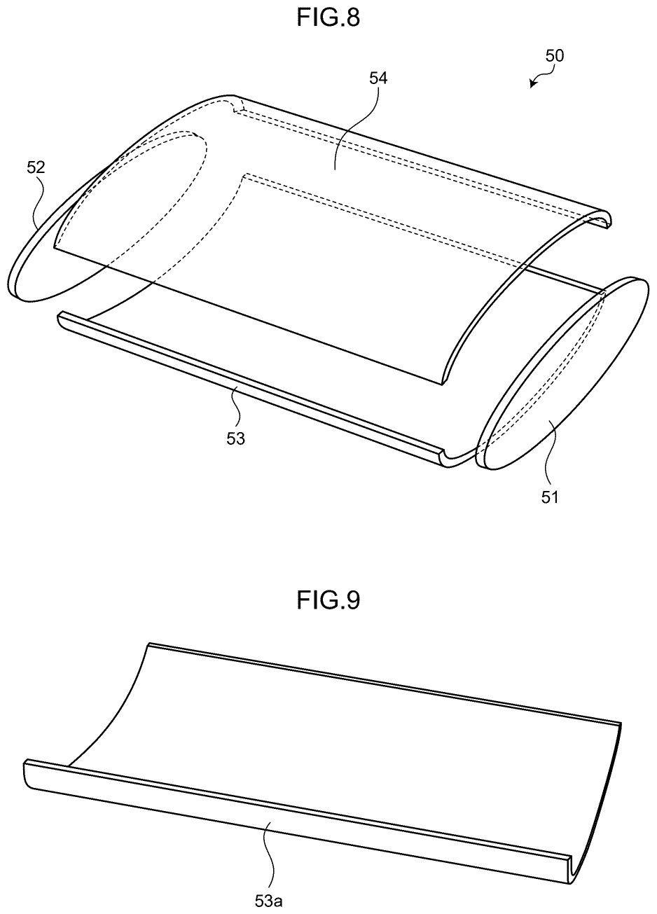

Note that at the time of covering the inner surface with the fiber-reinforced composite material layer 31 and the outer surface with the fiber-reinforced composite material layer 30, when the sintered body is integrated and the hollow interior is inaccessible, after the silicon infiltration and silicon carbide reaction sintering step, the fiber-reinforced composite material is placed in respective portions, which correspond to the inner surfaces defining the hollow interior, of the divided sintered body portions, and the composite integration treatment of the fiber-reinforced composite material is performed to form the fiber-reinforced composite material layer 31 on the portions, which correspond to the inner surfaces. Subsequently, as illustrated in FIGS. 9 to 11, after the respective portions 51a, 52a, 53a, and 54a each made of a sintered body in which the fiber-reinforced composite material layer 31 is formed on the inner surface are assembled, the fiber-reinforced composite material is disposed on the outer surface, and a composite integration treatment of the fiber-reinforced composite material is performed, thus enabling the respective portions 51a, 52a, 53a, and 54a to be joined. The fiber-reinforced composite material on the outer surface can cover the joint portion of the matrix base material 20 made of the ceramic material on the inner side, thus reinforcing the joint portion.

Additionally, after the shaping step is performed on each of the divided portions, the respective portions may be combined and rejoined to be integrated with each other using a raw material mixture and a binder. Furthermore, in the silicon infiltration and silicon carbide reaction sintering step, the respective portions can be integrated with each other through reaction sintering by the silicon-carbide reaction. At this time, the divided joint surfaces are integrated with each other in the same manner as the other portions. The joint portion between the divided portions is sintered in the equivalent manner as the other portions, thus achieving strength characteristics equivalent to the other portions. Note that the choice of any of the above methods is determined based on the final shape.

Note that the method for producing the ceramic matrix composite sintered body 10B in FIG. 7 further includes a silicon infiltration and silicon carbide reaction sintering step (step S21) after the heat treatment step of step S11. In the silicon infiltration and silicon carbide reaction sintering step of step S21, the matrix material of the fiber-reinforced composite material layer 30 on the outer surface carbonized in the heat treatment step of step S11 is converted into silicon carbide. As a result, the matrix material of the fiber-reinforced composite material layer 30 becomes a silicon carbide ceramic material, thus enhancing the heat resistance as compared with the case of the plastic resin. After this, the finishing step of step S7 is performed.

The material composition of the reinforcing fibers and the matrix materials in the fiber-reinforced composite material layers 30 and 31 can be configured in any combination in accordance with the use environmental conditions. Furthermore, the combinations of the reinforcing fibers and the matrix materials in the fiber-reinforced composite material layers 30 and 31 respectively on the outer surface and the inner surface are not necessarily the same. Preferably, the fiber-reinforced composite material layer 31 on the inner surface has characteristics of lower elastic modulus and higher flexibility than the fiber-reinforced composite material layer 30 on the outer surface.

Note that the silicon infiltration and silicon carbide reaction sintering step of step S21 may be performed after the heat treatment step of step S11 in the fifth embodiment. Additionally, the heat treatment step of step S11 and the silicon infiltration and silicon carbide reaction sintering step of step S21 may be performed after the composite integration step of step S6 in the fourth embodiment. Furthermore, as appropriate, a coating layer may be formed on the surface of the obtained ceramic matrix composite sintered body 10B.

In the sixth embodiment, in the shaping step, the substrate is formed to internally have a hollow structure, and the fiber-reinforced composite material layers 30 and 31 are integrated with the outer surface and the inner surface, respectively. This can produce the ceramic matrix composite sintered body 10B having the hollow structure described in the third embodiment.

### Examples

Next, an example of the ceramic matrix composite sintered body 10 according to the first embodiment will be described. The ceramic matrix composite sintered body 10 is produced in accordance with the production method described in the fourth embodiment. First, in the raw material mixing step of step S1, boron carbide F150 available from 3M is used as a boron carbide powder of a raw material mixture, powdered phenolic resin PG-9400 available from Gunei Chemical Industry Co., Ltd is used as a binder resin, and a graphite powder available from FUJIFILM Wako Pure Chemical Corporation is used as filler carbon. The raw material mixture is prepared by adjusting the compounding ratio of various raw materials such that the volume content of boron carbide after sintering is 50% or more and the volume content of voids in a green body is 15% or more when molded at a maximum molding pressure of less than 40 MPa in the molding step of step S2.

Next, in the molding step of step S2, the raw material mixture is charged into a mold, i.e., filling a mold with the raw material mixture, and is heated to 150° C. as a heating condition in a range where the maximum molding pressure is less than 40 MPa. Then, the temperature is maintained for 90 minutes, so that the binder resin is cured and molded to obtain a green body. Upon confirming the bulk specific gravity and the voids of the green body, the bulk specific gravity is 1.8, and the volume content of the voids is approximately 17%.

Subsequently, in the heat treatment step of step S3, the green body is subjected to a heat treatment in an inert atmosphere to carbonize the binder resin, thereby obtaining a fired body. In the heat treatment, heating is performed while the atmosphere in the furnace is evacuated by a rotary pump. At this time, the green body is heated to approximately 800° C. in a free state without being pressurized. Then, the temperature is maintained for 30 minutes, and then the green body is allowed to cool slowly to obtain a fired body. As compared with the green body before firing, the weight of the fired body after firing is reduced by approximately 5%, and the size is changed by less than 1% with almost no change. Additionally, the volume content of voids in the fired body after firing is approximately 278. No crack is generated in the fired body.

Next, in the silicon infiltration and silicon carbide reaction sintering step of step S5, metal silicon is melted using a high-temperature vacuum furnace, the melted metal silicon is infiltrated into the fired body having the shape obtained in the heat treatment step of step S3, the infiltrated metal silicon is reacted with the carbon of the fired body to form silicon carbide, and the silicon carbide is further subjected to reaction sintering to obtain a sintered body. The bulk specific gravity of the sintered body after sintering is approximately 2.7, and the dimension of the sintered body after sintering is changed by approximately 1% as compared with the fired body before sintering. Additionally, no distortion or cracks are observed in the sintered body after sintering.

A test piece is cut out from the sintered body obtained after the silicon infiltration and silicon carbide reaction sintering step of step S5, and main material physical properties are confirmed. Here, the bending strength, the fracture toughness value, and the elastic modulus are confirmed by performing a four-point bending test in accordance with Japanese Industrial Standards (JIS). As a result, the bending strength is 280 MPa, the fracture toughness value is 4.1 MPa·m^{1/2}, and the elastic modulus is 390 GPa.

On the other hand, in the composite integration step of step S6, preparation is made for forming the ceramic matrix composite sintered body 10 by covering the surface of the sintered body obtained in step S5 with the fiber-reinforced composite material layer 30. A prepreg sheet including Dialead (registered trademark) K63712 available from Mitsubishi Chemical Corporation, which is a pitch-based carbon fiber as a carbon fiber, and an epoxy resin is laminated, as a fiber-reinforced composite material, onto the surface of the sintered body, and heated and cured to achieve integral molding. At this time, composite formation is performed in which the thickness of the matrix base material 20 is set to 2.4 mm, and the thickness of each of the upper and lower surfaces of the fiber-reinforced composite material layer 30 on the surface of the matrix base material 20 is set to 0.3 mm. The ceramic matrix composite sintered body 10 thus obtained has a bulk specific gravity of 2.45.

Additionally, a test piece is cut out from the ceramic matrix composite sintered body 10 thus obtained, and main material physical properties are confirmed in the same manner as described above. The ceramic matrix composite sintered body 10 has an elastic modulus of 388 GPa, showing almost no change from the elastic modulus of the sintered body before forming the composite. However, the specific modulus enhances from 144.4 GPa to 158.4 GPa because the bulk specific gravity changes from 2.7 to 2.45. It is found that the bending strength increases from 280 MPa before forming the composite to 300 MPa. At this time, it is found that the fracture mode shows brittle fracture before forming the composite, but after forming the composite, fracture does not occur at once even if a crack occurs, which means that a toughness fracture mode is obtained, a fracture strain is approximately twice, and a fracture energy is improved to three times or more.

The features illustrated in connection with the above embodiments are illustrative only and may be combined with the other known techniques. The embodiments may be combined with each other. The features may partially be omitted or modified without departing from the gist.

### REFERENCE SIGNS LIST

10, 10A, 10B ceramic matrix composite sintered body; 11 base; 12 main body; 20 matrix base material; 30, 31 fiber-reinforced composite material layer; 40 reinforcing structure member; 41 plate; 42 rod; 50 substrate; 51, 52, 61, 62 bottom surface; 53, 54, 63 side surface.

1. A ceramic matrix composite sintered body comprising:
a matrix base material that includes a ceramic material containing boron carbide, silicon carbide, and metal silicon or a silicon alloy and containing no reinforcing fiber inside; and
a fiber-reinforced composite material layer covering a surface of the matrix base material and containing a reinforcing fiber, wherein
in a case where the fiber-reinforced composite material layer includes the fiber reinforced metal, a matrix material of the fiber-reinforced composite material layer includes a light alloy having a specific gravity lower than that of the matrix base material, and
the reinforcing fiber includes at least one material selected from the group consisting of an inorganic fiber, a carbon fiber, and an organic fiber.

2. (canceled)

3. The ceramic matrix composite sintered body according to claim 1, further comprising a reinforcing structure member made of a fiber-reinforced composite material inside the matrix base material, wherein
the reinforcing structure member is integrated with the matrix base material.

4. The ceramic matrix composite sintered body according to claim 1, wherein
the matrix base material has a hollow structure, and
the fiber-reinforced composite material layer covers an outer surface of the matrix base material, and an inner surface of the matrix base material facing the hollow structure.

5. The ceramic matrix composite sintered body according to claim 1, wherein the matrix base material contains the boron carbide at a volume ratio of 50% or more.

6. The ceramic matrix composite sintered body according to claim 1, further comprising a coating layer on a surface of the fiber-reinforced composite material layer.

7.-8. (canceled)

9. A method for producing a ceramic matrix composite sintered body, the method comprising:
obtaining a raw material mixture containing a boron carbide powder, a binder resin as a carbon precursor, and a matrix filler as a silicon carbide precursor;
charging, into a mold, the raw material mixture, and heating and pressurizing the raw material mixture to obtain a green body;
subjecting the green body to a heat treatment in an inert atmosphere, and carbonizing the binder resin to obtain a fired body;
shaping the fired body through machining to obtain a substrate;
a silicon infiltration and silicon carbide reaction sintering of infiltrating the substrate with metal silicon or a silicon alloy, converting carbon inside the substrate into silicon carbide, and sintering the substrate to obtain a sintered body serving as a matrix base material; and
a composite integration of compositely combining a surface of the sintered body with a fiber-reinforced composite material layer containing a reinforcing fiber, and integrating the sintered body with the fiber-reinforced composite material layer, wherein
in a case where the fiber-reinforced composite material layer includes the fiber reinforced metal, a matrix material of the fiber-reinforced composite material layer includes a light alloy having a specific gravity lower than that of the matrix base material, and
the reinforcing fiber includes at least one material selected from the group consisting of an inorganic fiber, a carbon fiber, and an organic fiber.

10. The method for producing a ceramic matrix composite sintered body according to claim 9, wherein in the shaping, a reinforcing structure member made of a fiber-reinforced composite material is embedded in an inside of the fired body, and an outer shape of the fired body is shaped to form the substrate, and
in the silicon infiltration and silicon carbide reaction sintering, the reinforcing structure member is integrated with the fired body.

11. The method for producing a ceramic matrix composite sintered body according to claim 9, wherein in the shaping, the substrate is formed to internally have a hollow structure, and
in the composite integration, the fiber-reinforced composite material layer is integrated with an inner surface of the sintered body facing the hollow structure, and then the fiber-reinforced composite material layer is integrated with an outer surface of the sintered body.

12.-13. (canceled)

14. The ceramic matrix composite sintered body according to claim 3, wherein
the matrix base material has a hollow structure, and
the fiber-reinforced composite material layer covers an outer surface of the matrix base material, and an inner surface of the matrix base material facing the hollow structure.

15. The ceramic matrix composite sintered body according to claim 3, wherein the matrix base material contains the boron carbide at a volume ratio of 50% or more.

16. The ceramic matrix composite sintered body according to claim 4, wherein the matrix base material contains the boron carbide at a volume ratio of 50% or more.

17. The ceramic matrix composite sintered body according to claim 14, wherein the matrix base material contains the boron carbide at a volume ratio of 50% or more.

18. The ceramic matrix composite sintered body according to claim 3, further comprising a coating layer on a surface of the fiber-reinforced composite material layer.

19. The ceramic matrix composite sintered body according to claim 4, further comprising a coating layer on a surface of the fiber-reinforced composite material layer.

20. The ceramic matrix composite sintered body according to claim 14, further comprising a coating layer on a surface of the fiber-reinforced composite material layer.

21. The ceramic matrix composite sintered body according to claim 5, further comprising a coating layer on a surface of the fiber-reinforced composite material layer.

22. The ceramic matrix composite sintered body according to claim 15, further comprising a coating layer on a surface of the fiber-reinforced composite material layer.

23. The ceramic matrix composite sintered body according to claim 16, further comprising a coating layer on a surface of the fiber-reinforced composite material layer.

24. The ceramic matrix composite sintered body according to claim 17, further comprising a coating layer on a surface of the fiber-reinforced composite material layer.
